(19) United States
(12) Patent Application Publication
(10) Pub. No.: US 2012/0294672 A1
(43) Pub. Date: Nov. 22, 2012

(54) Tripod Adapter for Shooting Rests and Other Accessories

(75) Inventor: Kim Melvin Hicks, Fredericksburg, TX (US)

(73) Assignee: REAL HICKS PROPERTIES, LLC, Fredericksburg, TX (US)

(21) Appl. No.: 13/471,658

(22) Filed: May 15, 2012

Related U.S. Application Data
(60) Provisional application No. 61/486,920, filed on May 17, 2011.

(51) Int. Cl. F16D 1/00; B23P 17/00

(52) U.S. Cl. 403/299; 29/401.1

(57) ABSTRACT

An adapter installs on the head of a conventional tripod, bipod, monopod, or other type of stand. The adapter threads directly on the threaded bolt of the stand or uses a busing to thread onto the smaller bolt. Once installed, the top opening of the adapter can receive the quick-connect stem of an accessory, such as a shooting rest, riffle rest, swivel ballhead camera or scope mount, or other accessory.

### CROSS-REFERENCE TO RELATED APPLICATIONS

This is a non-provisional of U.S. Appl. No. 61/486,920, filed 17 May 2011, which is incorporated herein by reference and to which priority is claimed.

### BACKGROUND

Hunters, recreational shooters, photographers, videographers, campers, hikers, law enforcement personnel, and military personnel use stands to support a number of elements, such as cameras, spotting scopes, binoculars, weapons, sights, and the like. These stands can be tripods, bipods, and monopods, which can be “the set of sticks” style or “the set of legs” style—as they are commonly referred to.

In general, these stands have different heads. In some instances, quick-change plates of various sizes and shapes can be used on the heads to attach spotting scopes, binoculars, still cameras, video cameras, and any other type of specialized mount to the top of the head. The tripod, bipod, or monopod stands can also come with a ball mount.

Almost all of the stands manufactured around the world have a bolt installed at the top of the head or on the quick change plate. The bolt is used to mount an accessory at the top of the stand, and the bolt is typically a ¼ inch bolt (20 threads per inch) or a ⅜ inch bolt (16 threads per inch).

Attaching an accessory to a stand having such a bolt may not always be practical and desirable. Moreover, being able to use one stand with a number of accessories that can be swapped out or easily changed on the same stand can be advantageous for sportsmen, photographers, campers, law enforcement personnel, military personnel, and others.

The subject matter of the present disclosure is directed to overcoming, or at least reducing the effects of, one or more of the problems set forth above.

### SUMMARY OF THE DISCLOSURE

An adapter system adapts an accessory for support on a stand, a baseplate, a support bag, or a clamp. The accessory can be shooting rest, a rifle rest, a swivel ballhead mount, binoculars, a camera, a spotting scope, and a sight. In the adapter system, a connecting stem and adapter interconnect together to affix the accessory on a support, such as a stand, a baseplate, a support bag, a clamp, or other fixture. A first end of the connecting stem connects to a supported surface of the accessory and can, for example, thread into a threaded opening of the accessory or affix therein by other means, such as a knurled surface.

The adapter has a top adapted to support the accessory's supported surface, and a non-threaded opening in the top surface can accept a second end of the connecting stem. In particular, the second end of the connecting stem can have one or more biased balls that engage in the non-threaded opening to hold the stem therein.

The adapter also has a bottom adapted to rest on a supporting surface of the support, and a threaded opening defined in the bottom can affix to the supporting surface of the support. For example, the supporting surface can have a threaded fastener extending therefrom, and the adapter's threaded opening can thread thereon to affix the adapter to the supporting surface. If the threaded fastener is smaller than the threaded opening, a bushing having an external thread and an internal thread can be used. The internal thread threads onto the threaded fastener, and the external thread threads into the threaded opening on the bottom of the adapter to affix the adapter to the supporting surface.

As noted above, the supporting surface may be part of a baseplate used in the adapter system. The baseplate has a threaded fastener extending from it for threading into the threaded opening in the bottom of the adapter. The fastener can be permanently affixed to the baseplate, or it can fit through a plate opening from one side and thread into the adapter at the other side of the baseplate. Additional openings can be provided in the plate to affix the plate to other surfaces.

In conjunction with the baseplate, the adapter system can use a support bag having a first pocket for holding the baseplate therein. A bag opening in this pocket allows for passage of the plate's threaded fastener so the adapter can affix to the baseplate as noted above. In addition to this first pocket, the support bag has one or more second pockets that hold weights therein, such as sand bags.

As noted above, the supporting surface may be part of a clamp or a stand used in the adapter system. The clamp or stand has a threaded fastener extending from it onto which the adapter affixes. The clamp can clamp onto a support, and the stand can be a tripod, a bipod, and a monopod. Finally, the adapter and can include a particular accessory to which the first end of the connecting stem connects. The accessory can be a shooting rest, a rifle rest, a swivel ballhead mount, binoculars, a camera, a spotting scope, and a sight.

The foregoing summary is not intended to summarize each potential embodiment or every aspect of the present disclosure.

### BRIEF DESCRIPTION OF THE DRAWINGS

FIG. 1 illustrates an adapter system according to the present disclosure for affixing accessories on a support using an adapter and a quick-connect stem.

FIG. 2 shows one embodiment of the adapter with the quick-connect stem disposed therein.

FIGS. 3A-3B show another embodiment of the adapter with the quick-connect stem disposed therein.

FIG. 4 shows the adapter with a converter bushing.

FIGS. 5A-5B shows a tri-pod stand in stages of conversion with the adapter to support an accessory.

FIGS. 6A-6C show a tri-pod stand with the adapter to support a shooting rest, a swivel ballhead mount, and a rifle rest, respectively.

FIG. 7 shows the adapter installed on an ancillary baseplate of the adapter system.

FIG. 8 shows the adapter installed on a clamp of the adapter system.

FIGS. 9A-9D show a support bag of the adapter system adapted to accept a baseplate and the adapter.

FIG. 10 is a cross-sectional view depicting the adapter, the baseplate, and the support bag supporting a shooting rest of the adapter system.

### DETAILED DESCRIPTION

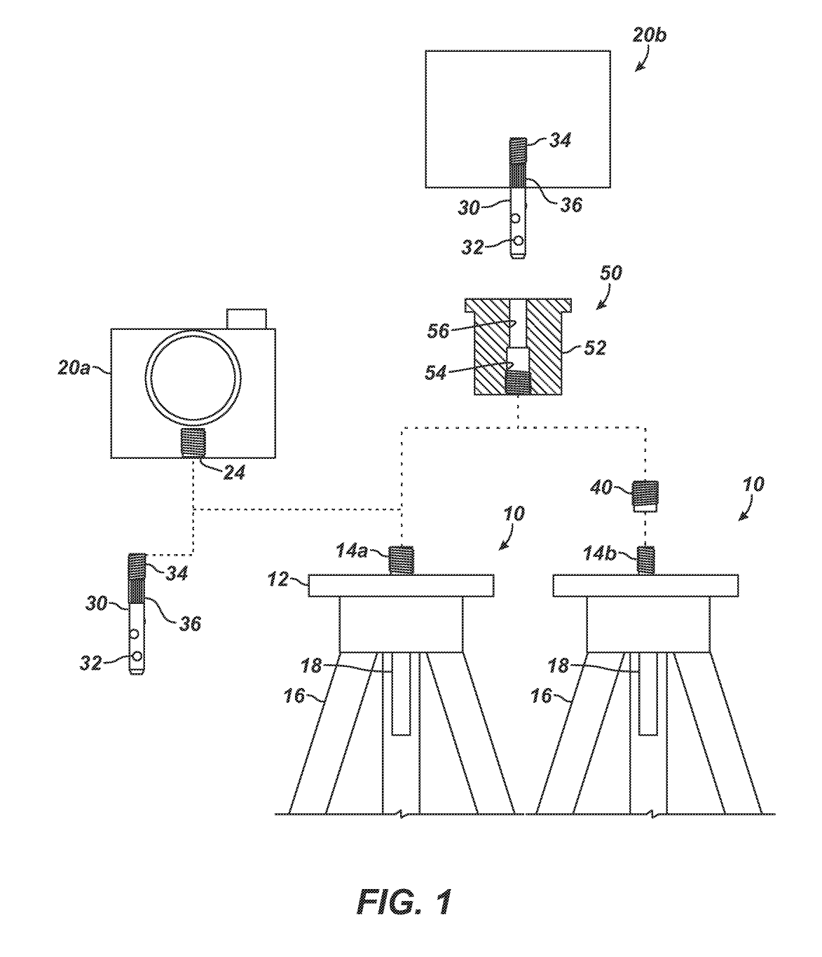

An adapter system as disclosed herein has components that may be arranged and used together for affixing an accessory on a support, such as a stand, clamp, baseplate, support bag, fence, car window, or other fixture. Moreover, one or more of the components may be arranged and used along with an accessory to support the accessory on a fixture. As shown in FIG. 1, the adapter system includes an adapter 50 for attaching an accessory 20 with a quick-connect stem 30 on a stand 10. In general, the stand 10 can be a tripod, bipod, monopod, or any type of conventional stand. A head 12 on the stand 10 has an extending bolt 14 for attachment to a camera 20 or other conventional device. The height of the head 12 can be adjusted either by adjusting the lengths of the legs 16 or by adjusting a center pole 18 on which the head 12 rests. For some stands, the bolt 14 is a ¼″ bolt (20 threads per inch) or a ⅜″ bolt (16 threads per inch).

The adapter 50 converts the standard stand 10 with its conventional head 12 for use with a quick-connect stem 32 on an accessory 20. In this way, the adapter 50 offers great flexibility for hunters, recreational shooters, photographers, videographers, campers, and hikers as well as meeting special needs of law enforcement and military professionals. For example, most photographic stands, such as the stand 10 of FIG. 1, have a center column 18 that adjusts up and down. On the top of the column 18, the head 12 is used for supporting a camera 20a and has a ⅜″ bolt 14a or a ¼″ bolt 14b extending therefrom. Most camera bodies, such as the camera 20 in FIG. 1, have a ¼″ or a ⅜″ threaded opening 24 in the bottom of them so the camera 20 can thread directly onto the extending bolt 14a-b to be held on the stand 10.

With the camera 20a or other standard device removed from the stand 10, the adapter 50 can be installed instead. If the stand 10 has the larger bolt 14a, then the adapter 50 can thread directly on the head 12. If the stand 10 has the smaller bolt 14b, then a bushing 40 can thread into the adapter 50 so the two together can attach to the head's bolt 14b.

At this point, an accessory 20 having a quick-connect stem 30 can fit onto the adapter 50 so the accessory 20 can be used on the stand 10. As shown, the accessory 20b can have the quick-connect stem 30 permanently affixed thereon, and the accessory 20b can be a shooting rest or other device as discussed herein. Alternatively and as also shown in FIG. 1, the quick-connect stem 30 can thread onto the camera 20a or any other accessory 20 or standard device to be used with the adapter 50. For some devices, the quick connect stem 30 may be permanently affixed by embedding a knurled or serrated end 34 in material of the device. For other arrangements, a threaded end 36 of the quick connect stem 30 can thread into a threaded opening of the device, such as threading into the opening 24 in the camera 20 as shown. Thus, the quick-connect stem 30 can have an end 34 either ¼″ or ⅜″ threads and may also use a bushing (40) to connect to the camera 20a or other accessory 20b. In this way, a user can quickly change from a rifle rest accessory 20 on the stand to a camera 20, long range sight, or other device on the same stand 10 without having to perform any cumbersome changes or using two separate stands 10.

The adapter 50 can be used with various types of tripods, bipods, and monopods stands 10 manufactured around the world by different companies. The adapter 50 enables enthusiasts who use such stands 10 to be able to utilize any of the growing number of quick-connect accessories 20, such as shooting rests, mounts, and the like, as well as other devices (e.g., camera, binoculars, sights, etc.) on their existing tripod, bipod, and or monopod stand 10.

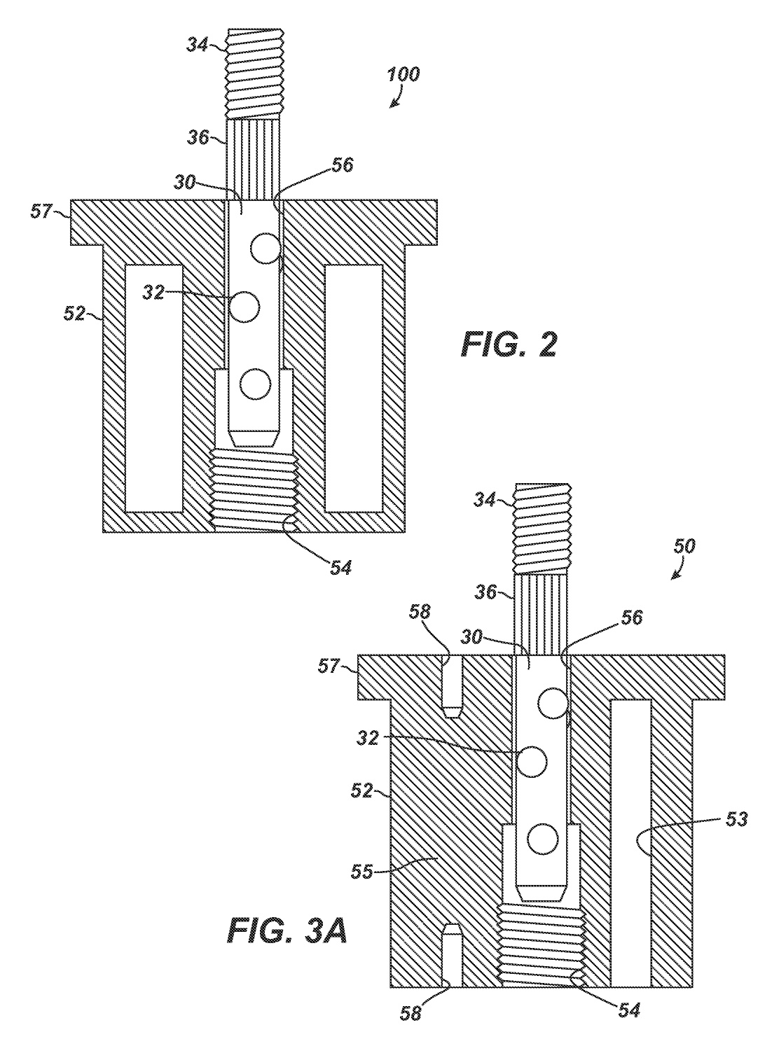

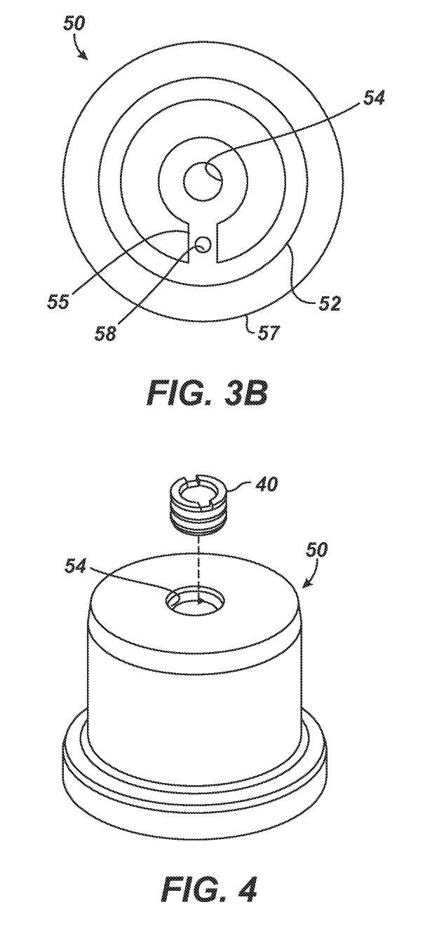

FIG. 2 shows one embodiment of the adapter 50 with the quick-connect stem 30 disposed therein, and FIG. 3A-3B show another embodiment of the adapter 50 with the quick-connect stem 30 disposed therein. In general, the adapter 50 can be solid or hollow. As shown in FIG. 2, for example, the adapter 50 can be hollow with closed top and bottom ends, although it could be completely solid. As shown in FIGS. 3A-3B, for example, the adapter 50 can be partially hollow with an open bottom end 53 and an interconnecting portion 55. These and other configurations are possible. In general, the adapter 50 can be composed of any desirable material, such as plastic, metal, steel, aluminum, or a combination of these.

The main cylindrical body 52 of the adapter 50 is approximately 1 1/16″ long and 1 7/16″ in diameter. The bottom end or portion of the adapter 50 can have a surface with the same diameter as the body 52, although it could have a greater size if desired. The top end or portion of the adapter 50 can have a larger round disc or surface 57 measuring approximately ¼″ thick and 1⅞″ in diameter to provide an additional support surface against which an accessory (20) can be supported. These dimensions are exemplary and can be modified for a given implementation.

The bottom of the main cylinder 52 of the adapter has a centered, threaded opening 54 that can be ⅜″ (16 threads per inch). As noted previously, a removable bushing (40; FIG. 1) with an external thread of ⅜″ and internal thread of ¼″ can screw into the center opening 54 if necessary. (This is shown in FIG. 4.) The top of the larger round disc 57 on top of the main cylinder 52 has a ⅜″ non-threaded opening 56 in the center of it. These two openings 54 and 56 can communicate with each other through the body 52 as shown.

As shown in FIG. 3A, smaller ⅛″ non-threaded openings 58 can be set approximately ¼″ from the edge of the center opening 54. The lower opening 58 can be used to engage a pin (not shown) that prevents rotation of the adapter 50 when installed on a stand (not shown). The upper opening 58 can likewise engage a pin (not shown) on an accessory to prevent it from rotating on the adapter 50 if desired.

The adapter 50 screws onto the existing threaded bolt (14; FIG. 1) at the top of the stand (10). Then, the quick-connect stem 30 connected to the accessory, camera, or the like (20: FIG. 1) plugs or inserts into the adapter 50 to be supported on the stand 10. The quick-connect stem 30 has a plurality of spring loaded ball bearings 32 that fit into the center opening 54 at the top of the adapter 50. Once installed in the center opening 54, the stem 30 may be able to rotate on the adapter 50, but engagement of the bearings 32 in the adapter's opening 56 restricts removal of the stem 30 unless a certain amount of force is applied. The bearings 32 can have an interference fit with the opening 56 to keep the stem 30 in place, or one or more of the bearings 32 may fit against grooves or shoulders in the opening 56 to hold the stem 30. Preferably, three or four bearings 32 are used to create a tight fit.

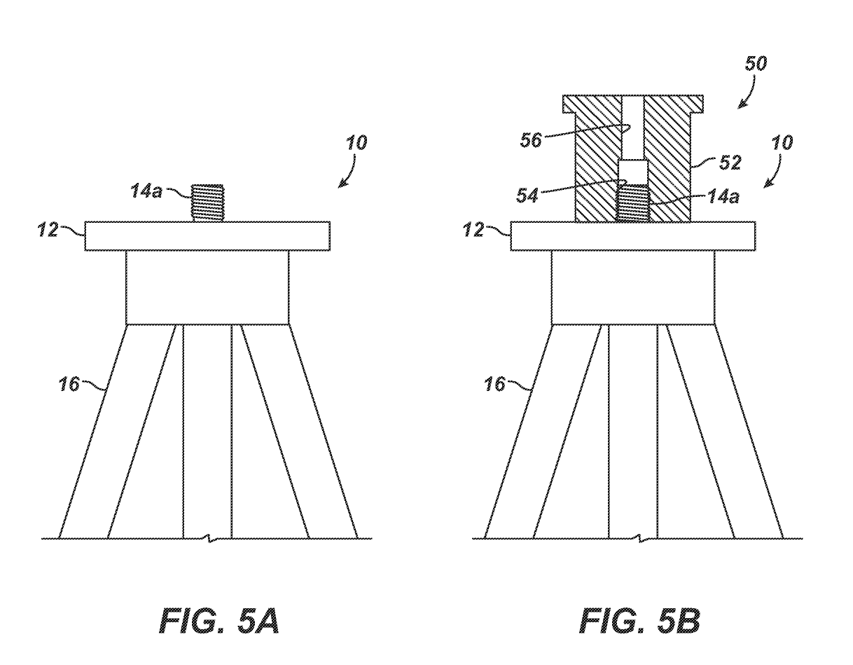

FIGS. 5A-5B shows a conventional tri-pod stand 10 in stages of conversion with an adapter 50 to support an accessory. Here, the tripod stand has the larger bolt 14a as shown in FIG. 5A. Therefore, the adapter 50 can thread directly onto the bolt 14a and tighten against the head 10 without the need of a bushing (40: FIG. 4). After attaching the adapter 50, any of a variety of accessories can be used on the adapter 50 as discussed below.

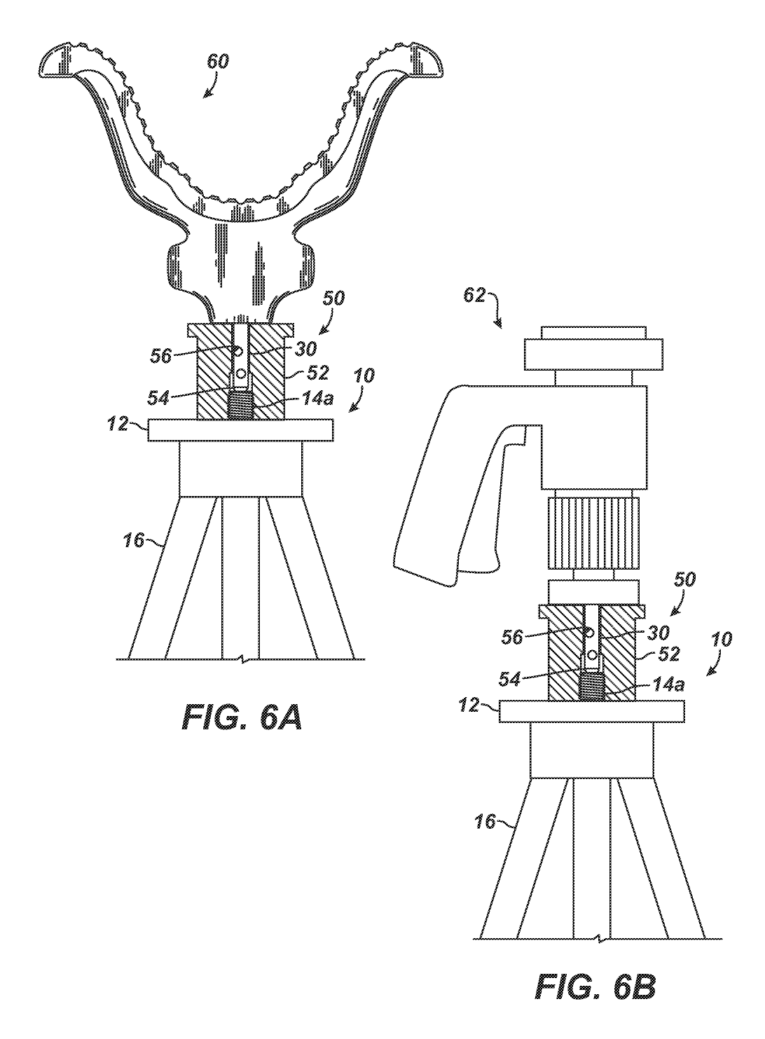

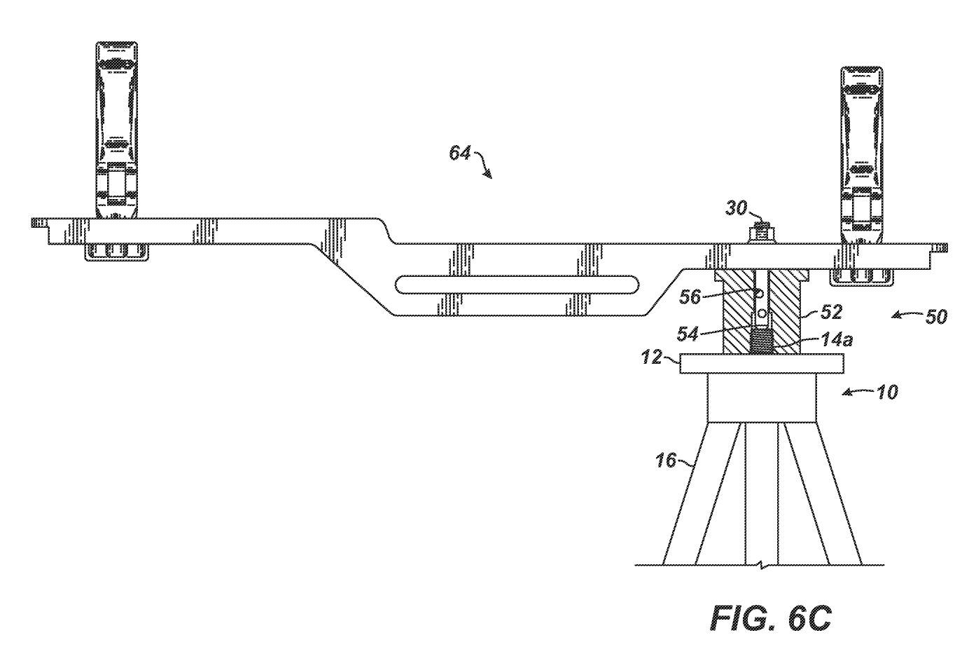

For example, the adapter 50 can support a shooting rest 62 (FIG. 6A) for using a rifle or pistol or a swivel ballhead mount 64 (FIG. 6B) for using spotting scopes, still cameras, and video cameras. As shown in FIG. 6C, a rifle rest 64 can also attach with a stem 30 to the adapter 50 on the stand 10.

As shown, the adapter 50 is designed to screw onto the ⅜″ threaded bolt 14 used for holding standard devices on the stand 14. Doing this allow other accessories having a quick-connect stem 30 to be used with this type of stand 10. The stem 30 can simply push into the opening 56 on the top of the adapter 50.

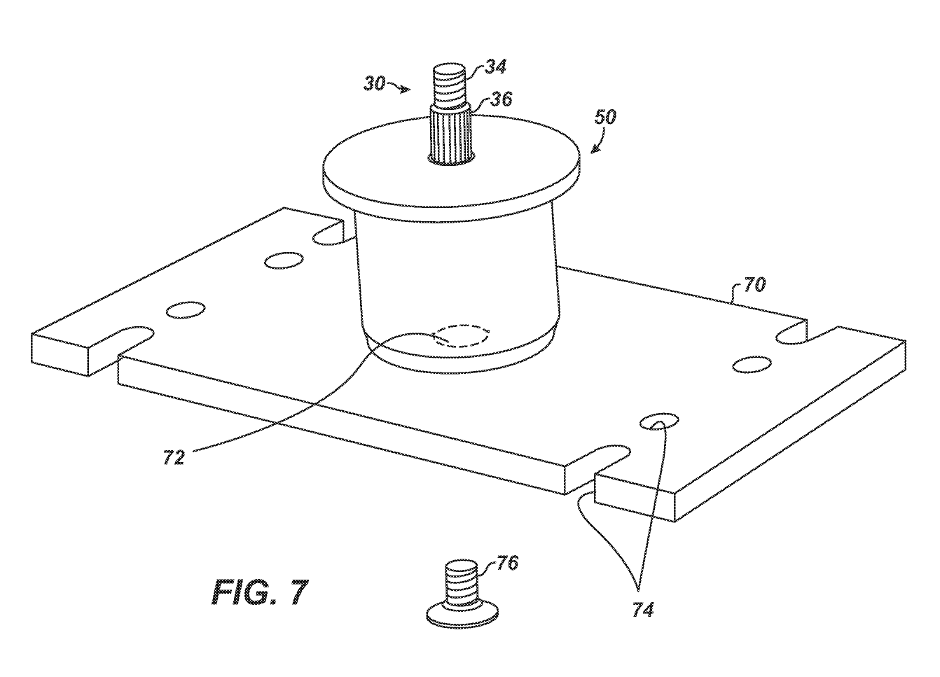

Although shown for use with a stand 10, such as a tripod, the disclosed adapter 50 can attach to a bolt of any number of fixtures or devices so an accessory 20 having a quick-connect stem 30 can attach to the fixtures. For example, FIG. 7 shows the adapter 50 used with a baseplate 70. A bolt 76 can insert in a central opening 72 in the plate 70, or the bolt 76 can be permanently affixed to the baseplate 70. Either way, the adapter 50 can thread onto the bolt 76. When this is done, any number of accessories 20 can be used with the baseplate 70 by inserting a quick-connect stem 30 into the adapter 50.

As noted above, the quick connect stem 30 can be integrated into an accessory (not shown) by using its knurled end 36, or the stem 30 can be retrofitted onto an accessory (not shown) by using its threaded end 34. In general, the baseplate 70 can be inserted into a support bag (discussed below) for support. In addition, the plate 70 can have various holes 74 and can affix with screws directly to a fixture, such as shooting house, window sill, table, bench, or the like.

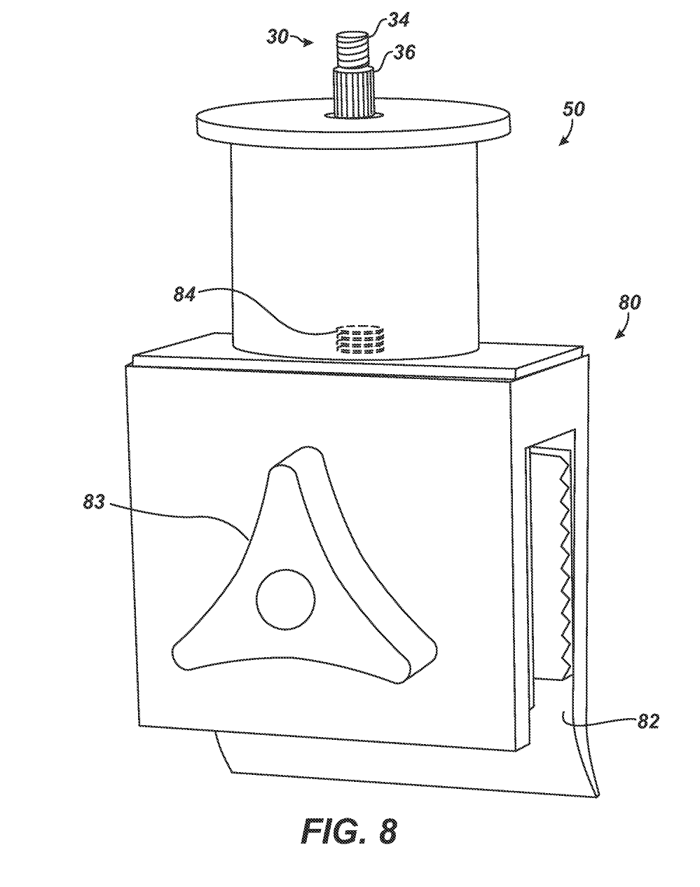

As another example, FIG. 8 shows the adapter 50 used on a clamp style mount 80, which can be used on a vehicle window or other fixture. The mount 80 has a clamp 82 and lock 83 that can fit on a window or other fixture. The adapter 50 affixes to a threaded bolt 84 at the top of the mount 80. When used this way, the clamp style mount 80 can hold any accessory (not shown) with a quick-connect stem 30 as discussed herein.

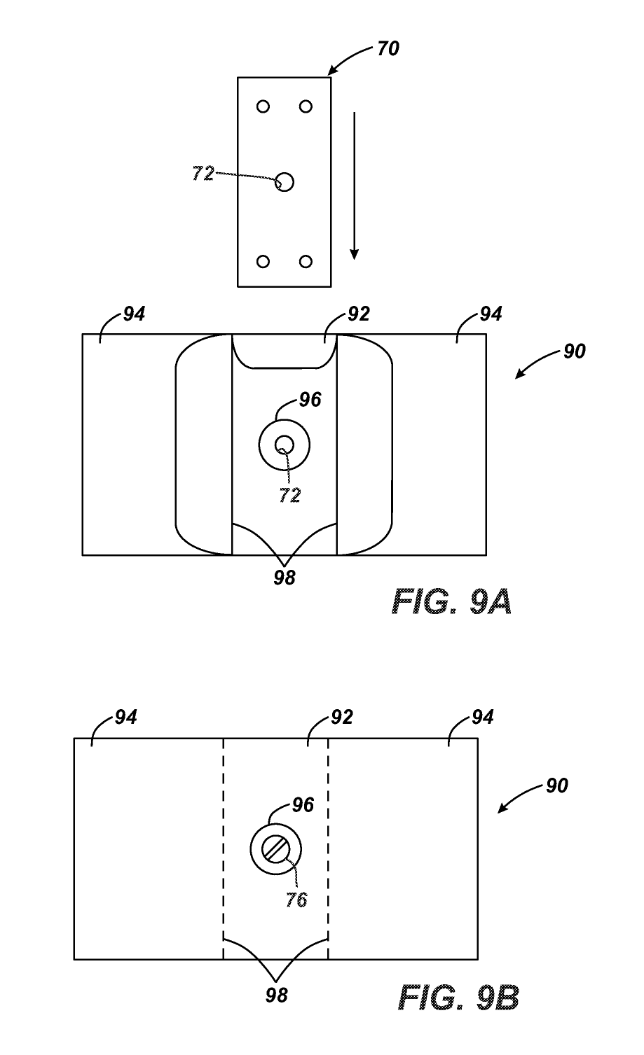

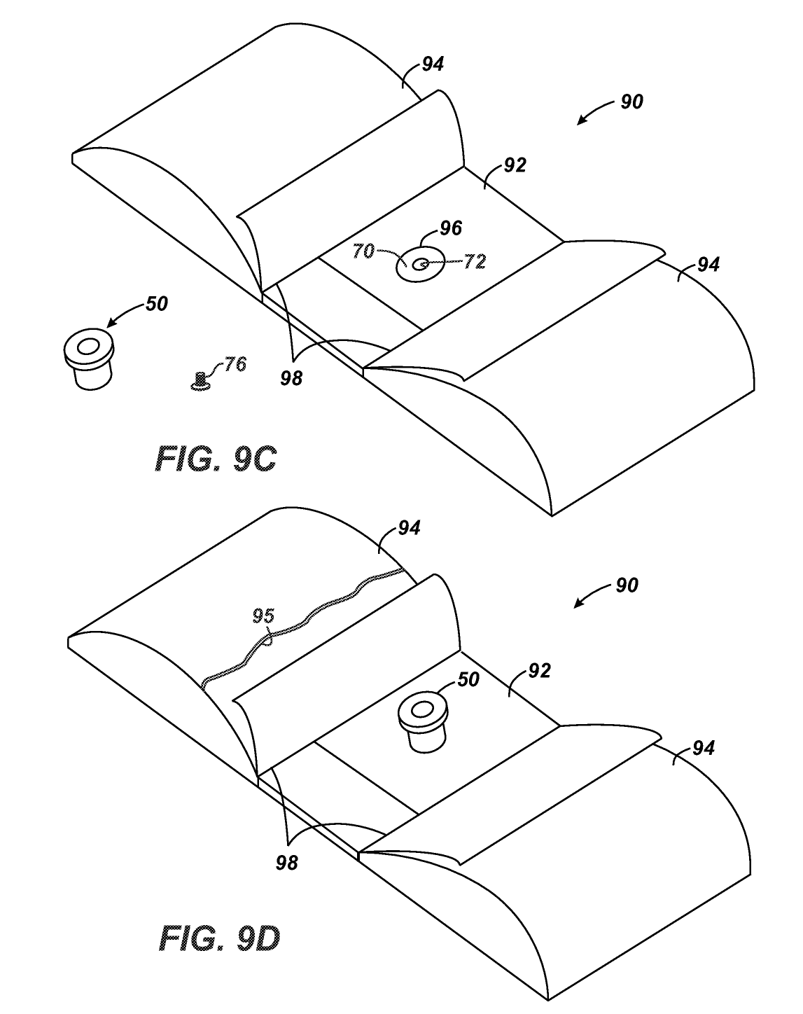

FIGS. 9A-9D show a support bag 90 adapted for use with the baseplate 70 (shown in FIG. 7) and the adapter 50. The support bag 90 may be made of a flexible material, such as a durable fabric, such as woven nylon. The support bag 90 has a central pocket 92, in which the baseplate 70 can be inserted (as seen from a top view in FIG. 9A). The central pocket 92 is shown with a pocket flap that can secure closed with a fastener (not shown) to keep the baseplate 70 within the pocket 92. In addition, the central pocket 92 has one or more holes (for example, central hole 96) aligned with the various holes 72 and 74 of the baseplate 70. In this manner, the baseplate 70 can have a bolt (not shown) in the hole 72 and through the pocket's central hole 96 onto which the adapter 50 can thread while the baseplate 70 is secured within the central pocket 92. Accordingly, once the adapter 50 is secured onto baseplate 70 within the support bag 90, the support bag 90 can hold any accessory with a quick-connect stem as discussed herein. FIG. 9C shows a bottom view of the support bag 90, illustrated with the threaded bolt 76 inserted into hole 72 of the baseplate 70, which is, in turn, secured in central pocket 92.

The support bag 90 is additionally shown with two side pockets 94 having pocket flaps 98 that can secure closed with fasteners (not shown). Although show with two side pockets 94, the support bag 90 may be adapted to accommodate more side pockets 94 around the central pocket 92, such as in a radial fashion around central pocket 92. Weights or other heavy items (not shown) can be inserted and secured into side pockets 94. Preferably, bags of sand or other fluidly-moving material are used for the weights in the side pockets 94. An outside pocket 95 can be supplied on one or more of the side pockets 94 so users can hold various items, such as sunglasses, lens caps, etc.

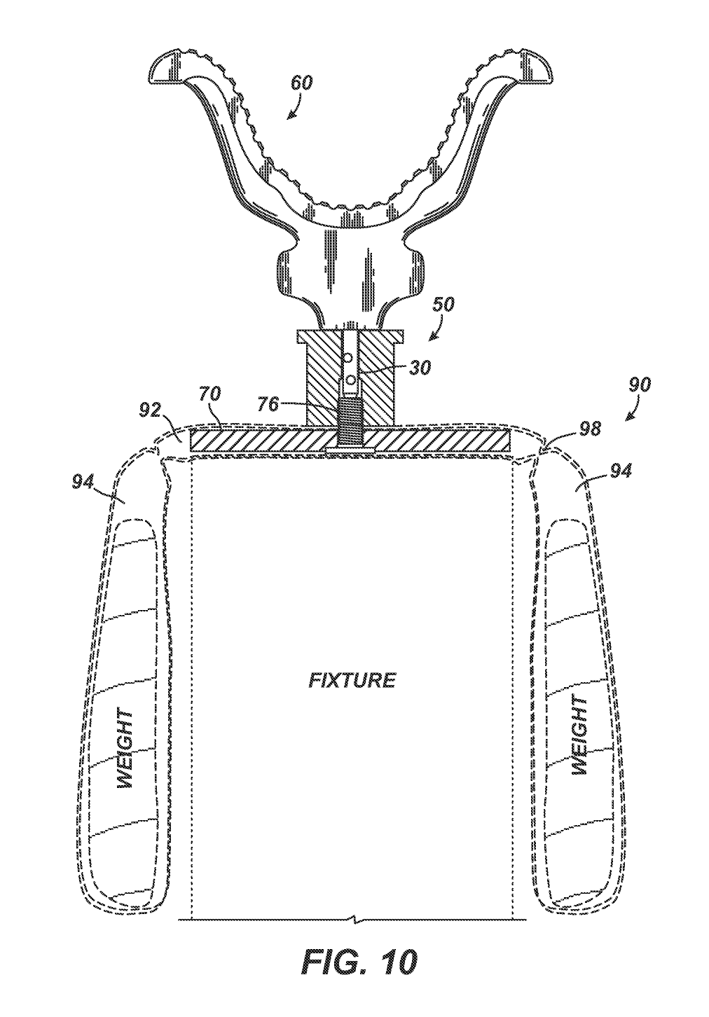

The support bag's 90 flexible material can fold along the seams 98 between the central pocket 92 and the side pockets 94. In this manner and as shown in FIG. 10, the support bag 90 can be placed on top of a surface of a fixture, such as shooting house, window sill, table, bench, fence, log, or the like, so that the baseplate 70 within the central pocket 92 rests on top of the surface while the side pockets 94 drape over either side of the surface. The flexibility of the support bag 90's material and the fluidity of the sand or other weight allow the bag 90 to conform to the shape of the surface used for support. Additionally, the weight of the bags of sand and the baseplate 70 within the bag 90 will serve to limit and steady any movement of the bag 90 so that the bag 90 may adequately be used as a gun stand, a binocular stand, a camera stand, or for some other purpose.

Although a few fixtures are discussed above, it will be appreciated with benefit of the present disclosure that stands, baseplates, clamps, support bags, or any other supports or fixtures having an acceptable bolt can use the adapter 50 threaded thereon for receiving an accessory 20 having a quick-connect stem 30. Various components have been described, including, for example, a support bag 90, a clamp 80, a baseplate 70, a shooting rest 60, a swivel mount 62, a rifle rest 64, an adapter 50, a bushing 40, a quick-connect stem 30, and accessories 20 or 20. One or more of these components may be arranged and used together for adapting an item, such as an accessory disclosed herein, for support on a fixture, such as a tripod stand, fence, car window, etc. Moreover, one or more of these components may be arranged and used along with an accessory as disclosed herein to support the accessory on a fixture. Accordingly, it will be appreciated with the benefit of the present disclosure that features described above in accordance with any embodiment or aspect of the disclosed subject matter can be utilized, either alone or in combination, with any other described feature, in any other embodiment or aspect of the disclosed subject matter.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. An accessory adapter system, comprising:
a connecting stem having first and second ends, the first end adapted to connect to a supported surface of an accessory; and
an adapter having first and second portions, the first portion defining a non-threaded opening adapted to accept the second end of the connecting stem, the second portion defining a threaded opening adapted to affix to a supporting surface.

2. The system of claim 1, wherein the first portion comprises a first surface adapted to support the supported surface, and wherein the second portion comprises a second surface adapted to rest on the supporting surface.

3. The system of claim 1, wherein the second end of the connecting stem comprises one or more biased balls disposed thereon and engaging in the non-threaded opening of the adapter.

4. The system of claim 1, wherein the first end of the connecting stem comprises thread releasably threading to the supported surface.

5. The system of claim 1, further comprising a bushing having an external thread and an internal thread, the external thread threading into the threaded opening of the second portion of the adapter, the internal thread threading onto a threaded fastener extending from the supporting surface and affixing the adapter to the supporting surface.

6. The system of claim 1, further comprising:
a baseplate having the supporting surface, and a threaded fastener extending from the supporting surface, the threaded fastener threading into the threaded opening in the second portion of the adapter and affixing the adapter and the baseplate together.

7. The system of claim 6, wherein the baseplate defines a plate opening having the threaded fastener disposed therein.

8. The system of claim 6, wherein the baseplate defines a plate opening adapted to affix the baseplate to a support.

9. The system of claim 6, further comprising a support bag defining a first pocket adapted to hold the baseplate therein and defining a bag opening for passage of the threaded fastener.

10. The system of claim 9, wherein the support bag defines at least one second pocket adapted to hold weight therein.

11. The system of claim 1, further comprising:
a clamp having the supporting surface; and
a threaded fastener extending from the supporting surface, the threaded fastener threading into the threaded opening in the second portion of the adapter and affixing the adapter and the clamp together.

12. The system of claim 1, further comprising:
a stand having the supporting surface; and
a threaded fastener extending from the supporting surface, the threaded fastener threading into the threaded opening in the second portion of the adapter and affixing the adapter and the stand together.

13. The system of claim 12, wherein the stand is selected from the group consisting of a tripod, a bipod, and a monopod.

14. The system of claim 1, further comprising an accessory having the supported surface, the accessory defining a surface opening in the supported surface, the surface opening adapted to connect to the second end of the connecting stem.

15. The system of claim 14, wherein the accessory is selected from the group consisting of a shooting rest, a rifle rest, a swivel ballhead mount, binoculars, a camera, a spotting scope, and a sight.

16. An adapter for coupling an accessory having a connecting stem to a support having a threaded fastener, the adapter comprising:
a body;
a top portion of the body having a top surface adapted to support the accessory and defining a non-threaded opening adapted to accept an end of the connecting stem inserted therein; and
a bottom portion of the body having a bottom surface adapted to engage the stand and defining a threaded opening adapted to accept the threaded fastener of the support.

17. The adapter of claim 16, further comprising a bushing having an external thread and an internal thread, the external thread threading into the threaded opening of the bottom portion of the body, the internal thread threading onto the threaded fastener extending from the supporting surface and affixing the body to the supporting surface.

18. A method of adapting a support having a threaded fastener extending therefrom to support an accessory, the method comprising:
affixing a threaded opening of an adapter to the threaded fastener on the support;
affixing a first end of a connecting stem to the accessory; and
affixing the accessory to the adapter by installing a second end of the connecting stem into a non-threaded opening of the adapter.

19. The method of claim 18, wherein affixing the first end of the connecting stem to the accessory comprises threading the first end to the accessory.

20. The method of claim 18, wherein affixing the threaded opening of the adapter to the threaded fastener on the support comprises threading external thread of a busing in the threaded opening of the adapter and threading internal threads of the bushing on the threaded fastener.

21. The method of claim 18, wherein installing the second end of the connecting into the non-threaded opening of the adapter comprises engaging one or more biased ball on the connecting stem inside the non-threaded opening.
